(19) United States
(12) Patent Application Publication
(10) Pub. No.: US 2004/0160994 A1
(43) Pub. Date: Aug. 19, 2004

(54) Multiple wavelength laser system

(76) Inventor: Kevin Jianluo Zhang, Santa Rosa, CA (US)

Correspondence Address: EDWARD S. SHERMAN, 5698 EAGLE ROCK CT., SANTA ROSA, CA, 95409, US

(21) Appl. No.: 10/371,360

(22) Filed: Feb. 19, 2003

(51) Int. Cl. H01S 3/30; H01S 3/10; H01S 3/08

(52) U.S. Cl. 372/23; 372/6

(57) ABSTRACT

A multiple wavelength laser is tunable in output beam frequency, number of output channels, spacing and power. The multiple wavelength laser system is made of two coupled stages of laser amplifiers, where the first stage comprises a series of optical gain mediums pumped with small power to operate near or above laser threshold, for stable operation. The second stage boosts the output of the first stage to high powers. As the optical gain mediums in the first stage are isolated by a de-multiplexing filter the can be separately powered, attenuated or otherwise modulated to provide an agile wavelength provisioning function, effective use of the pump power and direct-modulated laser signals.

### CROSS REFERENCE TO RELATED APPLICATIONS

None

### BACKGROUND OF THE INVENTION

The present invention relates to lasers useful in fiber optic telecommunication systems, particularly to multiple wavelength lasers that are tunable in the number of output beams of discrete frequency, their frequency/wavelength separation and optical power.

A multiple wavelength laser would have great utility in simplifying the hardware and design of optical communication systems that deploy wavelength division multiplexing (WDM).

As a matter of fact, people use many individual semiconductor DFB lasers to achieve a multiple laser source to meet current WDM requirement. However, these pre-selected DFB lasers are expensive and additional wavelength multiplexer is required to couple the multiple wavelengths into a single fiber.

Erbium doped fibers or glasses are ideal gain medium for near-infrared radiation. However, the erbium-doped fiber or glass is a homogenous line broadening at room temperature unless one cools the material at 77K.

One often makes a fiber ring laser to produce a single wavelength oscillation because the homogeneous line broadening nature of Erbium-doped fiberglass. The single wavelength can be tuned cross wide bandwidth about 30 nm.

Semiconductor materials exhibit inhomogeneous line broadening when deployed as optical gain medium, offering the potential for use as an optical gain medium having multi-longitudinal mode oscillations at a room temperature. However, Semiconductor materials have “fast photon”, that is with a relatively short lifetime of about 10 picoseconds, or 1000 times faster than erbium ions. This fast lifetime of photons causes cross phase modulation and cross saturation when multiple wavelength signals exist at the same time, resulting in unstable laser output.

Selected patents on fiber ring laser include U.S. Pat. Nos. 5,936,926; 6,033,926; 6,498,799; 6,490,388; 5,805,621; 5,504,771; 5,181,210; 5,524,118; 5,311,603; 5,337,375, which are incorporated herein by reference.

Alternative constructions of multiple wavelength lasers are disclosed in U.S. Pat. Nos. 6,018,536, 5,910,962 and published U.S. patent application No. 20020012366, which are incorporated herein by reference.

Although there are some reports to claim multiple wavelength oscillation realized in an erbium fiber laser, the laser wavelengths are not stable and primarily located in high gain region. Fundamentally, a laser system made of erbium-doped fibers cannot operate in multiple axial longitudinal modes simultaneously. The multiple laser power is not even and the wavelengths are not re-configurable.

A laser system with multiple wavelength output is highly demanded. Either continuous working (CW) or pulses lasers are used in optical interferometer measurement and sensor, photonic component characterization and WDM optical communication system.

It is therefore a first object of the present invention to provide a laser than provides a stable multiple wavelength output, yet capable of high power operation

A further objective of the present invention is to provide a multiple wavelength laser that can be reconfigured as necessary, having agile wavelength and power selection.

Yet another objective is to provide a laser output with tunable yet narrow spaced wavelengths in wide spectrum, as well as fewer wavelengths at proportionately higher power.

### SUMMARY OF INVENTION

In the present invention, the first object is achieved by providing a multiple-wavelength laser system in the form of a two-stage coupled optical amplifier. Stage I comprises a plurality of optical gain mediums and optionally optical variable attenuators, disposed between a wavelength de-multiplexing devices and a combiner, a narrower bandwidth comb type filter in serial arrangement within a laser feedback cavity. The optical gain mediums in Stage I are provided with sufficient power to operate at or just above the lasing threshold, such that a portion of optical energy generated therein is transmitted to Stage II via a unidirectional coupling device. Stage II comprises a second optical gain medium for controlling and increasing the power of the laser beam oscillating in stage I. Accordingly, the multiple wavelength laser system provides both stable power and a consistent wavelength output, as the function of the optical gain mediums in stage I are independent of the material line broadening mechanism.

In an additional embodiment the gain between two stage amplifiers to modulate the multiple wavelength output. For example the multiple-wavelength output is re-configurable. The re-configurable means one can adjust the number of wavelengths and the comb structure of the wavelength output. Unlike other laser, the output wavelengths are pre-fixed. As each of the optical gain medium stage I is independently controllable the number of wavelengths that can be provided in this laser system is variable, but generally a multiple of four wavelengths up to about 80 wavelengths or more.

In another embodiment a single pump source can be shared between the plural gain mediums of stage I via a pump light splitter, as minimum pump power is needed to meet oscillation condition at the preferred stable operating point, that is at or just above the lasing threshold.

Alternatively, the optical gain mediums in Stage I are optionally pumped with a distribution of pump powers that match the gain requirement for each wavelength, to equalize the output power at each discrete wavelength mode intended to correspond to an optical signal channel, depending on the gain amplification profile associated with Stage II.

In yet other embodiments the variable optical attenuation devices associated with each optical gain medium in stage I can regulate either the laser cavity losses or the pump power to equalize the output power at each discrete wavelength mode intended to correspond to an optical signal channel.

In another embodiment this laser outputs possess interlocked states of polarization. In other words, the state of polarization at each wavelength is fixed relative to the state of polarization laser at other wavelengths.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a schematic illustration showing the optical circuit and function of Stage I and Stage II

FIGS. 2a, 2b and 2c show the wavelength dependence transmission characteristics of the de-multiplexing filter and narrower band comb filters in Stage I that function to provide single mode selection.

FIG. 3 illustrate a multiple-wavelength fiber ring laser with Erbium-doped glass fibers as the optical gain medium in Stage I.

FIG. 4 illustrates a multiple wavelength fiber ring laser having semiconductor optical amplifiers as the optical gain medium in Stage I.

### DETAILED DESCRIPTION

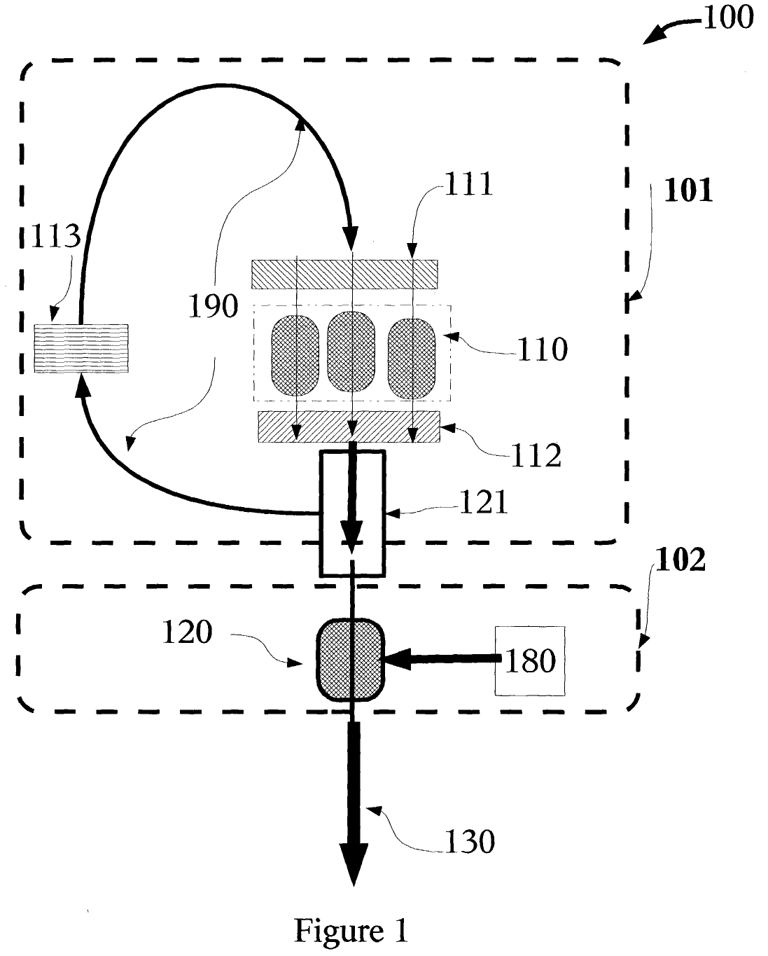

In accordance with the present invention FIG. 1 depicts the optical circuit and functions of stages I 101 and stage II 102 in laser system 100. Stage I is a ring oscillator 190 having a plurality of optical gain mediums 110 disposed in a parallel circuits between a wavelength de-multiplexing filter 111 and a combiner 112, and includes at least one power source (not shown) capable of providing sufficient energy to reach the lasing threshold in one or more of optical gain medium 110 of Stage 1. Ring oscillator circuit 190 further comprises a comb type optical filter 113 arranged in series with the plurality of optical gain mediums disposed between wavelength de-multiplexing filter 111 and combiner 112.

A splitter 121 is disposed within ring oscillator 190 for providing a portion of the resonant optical power to Stage II 120. Stage II 102 comprises a second optical gain medium 120 for receiving the optical power from splitter 121 and a power source 180 for optical amplification of the relatively low power, but stable lasing modes generated in stage I, to provide the high power multiple wavelength laser beam 130 that exits device 100.

Splitter 121 also functions as unidirectional coupler for receiving optical power from combiner 112 such that optical power reflected by comb type optical filter 113 does not enter optical gain mediums 110. Reflection by comb filter 113 prevents amplified spontaneous emission light from the gain medium 120 in stage II.

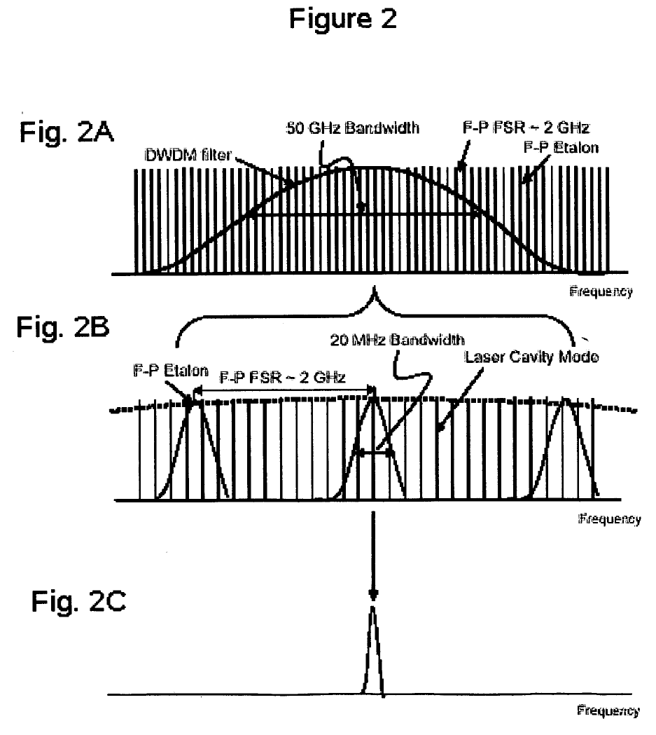

FIGS. 2a, b and c depicts the principle of single mode selection by using de-multiplexing filter 111, now labeled as DWDM filter, and comb type optical filter 113, now labeled as Fabry-Perot (F-P) Etalon, in which the wavelength dependent filter transmission characteristics are plotted in overlay with the possible laser cavity modes, (vertical lines in FIG. 2b) generated by the ring oscillator 190 and gain mediums 110 in stage I 101.

Considering a scale limit, FIG. 2a only shows the comb line type structure attributed to the periodic center wavelength positions of the bandpass regions of the Fabry-Perot (F-P) etalon filter. It should be noted that the horizontal frequency scale has increased in FIGS. 2b and 2c from FIG. 2a, as the frequency spacing between the F-P Etalon peaks of transmission peaks or bandpass regions in FIGS. 2a and 2b are constant.

Thus in FIG. 2a the DWDM filter provides a first order of mode selection between possible laser modes (that are actually much closer than the F-P etalon pass bands shown in FIG. 2b). The Final selected mode corresponding to the DWDM passband in FIG. 2a results from the Vernier type alignment of this mode due to dynamic tuning of the center wavelength position of the center F-P Etalon in FIG. 2b.

Accordingly, the laser system of the instant invention oscillates in a single mode/single frequency mode but at different wavelengths selected by the DWDM filter and the comb filter, yet with each of these modes having a very narrow linewidth (<10 kHz).

The stable multiple-wavelength oscillation can be achieved using Erbium-doped fibers and/or semiconductor optical amplifiers as the optical gain medium without the other performance limiting contributions of line broadening, cross saturation and cross-phase modulation. Thus the wavelength spacing between the selected modes in the output beam can be as narrow as one GHz.

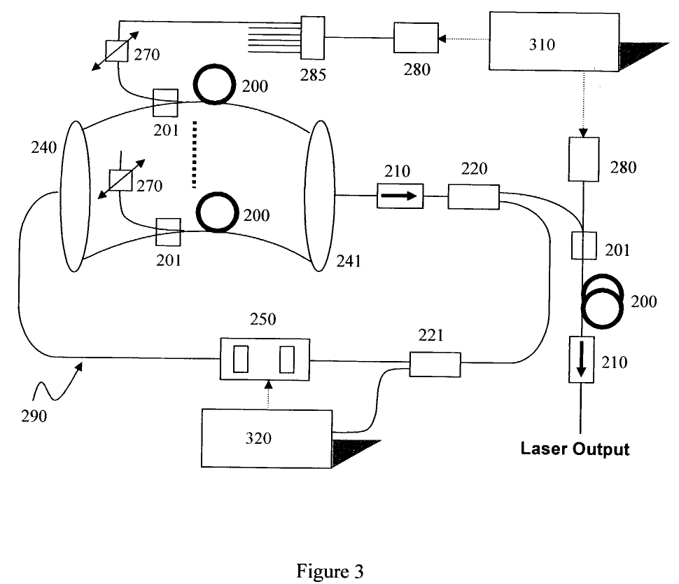

FIG. 3 illustrates a proposed optical circuit and components for another embodiment of the multiple wavelength laser wherein Erbium-doped glass fibers are the optical gain mediums in stage I. An array of gain mediums 200 are connected to a wavelength-multiplexing device 240 in one end and the other end to a wavelength-de-multiplexing device 241 via pump light multiplexing device 201. When the distributed pump light launches into the gain medium 200, via combiner 201, the optical signal passes through it is amplified in the optical gain medium associated with the wavelength selected by de-multiplexing filter 240.

Once the gain is larger than the total cavity loss, the laser oscillation will occur. The laser starts to operate. The multiple wavelength signals are circulating around the ring and in continuous working mode; the partial laser signals will couple out via an output coupler 220. Having an isolator 210 right before the output coupler 220 is preferred to increase the stability of the laser oscillation.

Within the ring cavity 290 an isolator 210 enforces a unidirectional light traveling toward comb frequency filter 250. Comb frequency filter 250 has a narrower bandwidth compared to wavelength de-multiplexing devices 240. Thus the cooperative Vernier effects, illustrated in FIG. 2, provided by either a fixed or adjustable band pass spacing or position of the comb filter 250 and multiplexing filter 240 limits the lasing modes of the ring cavity to the single frequency oscillation corresponding to the center wavelength of multiplexing filter 240. Accordingly, the laser output is more stable with increased signal to noise ratio.

Alternatively, the combiner 241 can be a multiplexing filter device that is the same or different in configuration than the de-multiplexing filter 240. In other embodiments of the invention the multiple optical gain mediums in Stage I can be disposed between a sequence of cascaded multiplexing and de-multiplexing filter such as multilayer thin film interference filter pair or fiber bragg gratings, as well the serial arrangement shown, for example when the multiplexing/de-multiplexing is accomplished by a planar arrayed-waveguide grating (AWG) or diffractive grating.

Splitter 220 extracts between about 50% to 30% of the optical power generated in stage I 101 for transmission to Stage II 102. The laser output of stage I 101 is amplified in Stage II by the second EDFA outside the ring cavity. As the part of this laser, the second stage EDFA is composed of a gain medium 200 and pump light multiplexing device 201 and an isolator 210.

Alternatives to using an F-P Etalon filter for comb filter 113 includes thin film interference filter of the bandpass or minus filter type, etalon filter, Fabry-Perot semiconductor optical amplifier filter. Further the wavelength discrimination characteristics of de-multiplexing filter 111 and the comb filter preferably have a bandwidth ratio about 10³ to 10⁴ times, and the comb filter has a free spectral range that is the 100th of the bandwidth of demultiplexing filter 111.

In a preferred embodiment a single optical pump beam and or power source is deployed via a splitter between the optical gain mediums 200 of stage I, as well as stage II, according to the needs or re-usage of the remaining pump power from the Stage II. A pump light driver 310 controls the pump light source 280.Thus, pump splitter 285 will distribute a pump power originated from a single pump light source 280, preferably with an unequal distribution profile to complement the non-uniform and wavelength dependent optical gain profile of the optical mediums 200, for optimum power efficiency.

An array of variable optical attenuators 270 is used to individually adjust the gain or to turn on and off particular wavelengths. The variable optical attenuators can be inside the ring cavity or outside the laser cavity. They provide additional features to this laser such as dynamic gain flattening and wavelength re-configuring. By providing an variable optical attenuation device in series with each of the optical gain medium in Stage I (or the pump source associated with the same optical gain medium) laser output intensity level and number of output wavelength numbers is reconfigured with selective attenuation of the optical gain medium or the pump intensity.

Further the multiple wavelength/frequency are not only pre-selected or pre-determined, but are digitally tunable in a continuous mode-hop-free mode, by active tuning of comb filter 110 and de-multiplexing devices 240 as well as the length of the ring oscillator circuit.

Alternatively, the multiple gain mediums 200 can be adjusted individually in gain by electronically tuning and/or modulating the optical variable attenuation devices or the pump source

The inventive multiple wavelength laser offers the potential for monolithic construction in the form of one or more planar integrated optical components, thus providing several advantages in addition to cost reduction, as the allocation of extra gain medium and agile, that is adaptive filters, in the device construction provides redundancy for yield or field failures

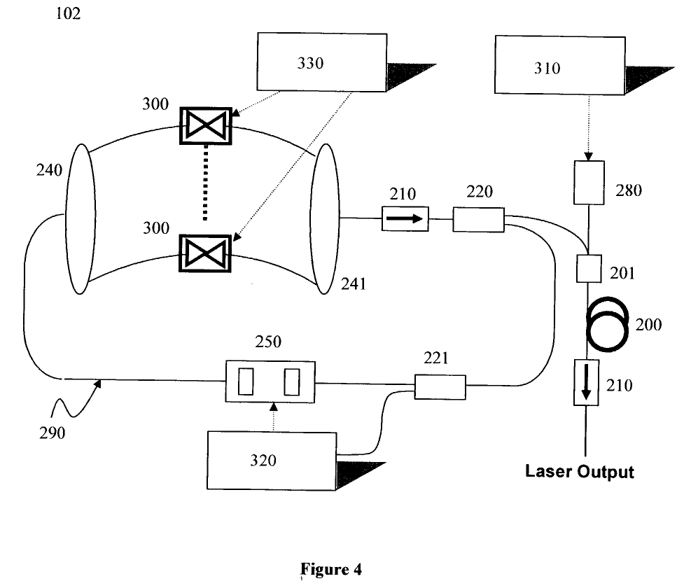

Accordingly, either or both Stage I and Stage II can be fabricated as a single integrated optical component wherein the filtering and optical regions and remainder of the ring resonator are fabricated on a planar waveguide device at least one stage is single integrated optical component. Further variable optical attenuators as well as a plurality of semiconductor amplifiers may be fabricated on the same planar waveguide, as further discussed with respect to FIG. 4, below.

FIG. 4 illustrates a proposed optical circuit and components for another embodiment of the multiple wavelength lasers wherein the optical gain medium is an array of semiconductor optical amplifier (SOA) 300. The deployment of SOA's as the gain mediums of stage I provides for electrical pumping and wider wavelength selection relative to an Erbium-doped fiber optical gain medium described with respect to FIG. 3. Further, the SOA gain array simplifies aspect of the device, eliminating a pump light multiplexing devices 201 and the variable optical attenuator 270, pump light splitter 290 and pump light source 280 in FIG. 3, by providing SOA gain driver 330 that performs equivalent functions.

Alternative forms of the optical gain medium in Stage I include doped optical fiber, semiconductor optical amplifier, parametric amplifier and Raman or Brillouin amplifier, and the like.

Further, rather independent from the choice of optical gain medium for Stage I the multiple wavelength laser of the instant invention preferably deploy an optical tap splitter 220. Optical tap splitter 220 extracts a small portion of the laser power as a “sample” for monitoring and control purposes, typically between about 0.5 to 3% of the optical power, but preferably 2%, is extracted and characterized to provide dynamic tuning.

The power for optical amplification in each of the optical gain mediums in Stage I is optionally a single optical pumping source used in conjunction with optical splitters, or multiple optical sources or an electrical power source.

Thus depending on the configuration of stages I and stages II, each stage may have its own optical pump source for the associated optical gain medium, or a single optical pump source may be split between stage I and Stage II, or shared by the optical gain medium of stage I. Further an active splitter circuit provides a method of laser wavelength selection by limiting or modulating the pump power to the optical gain medium or waveguide associated with the desired de-multiplexing device.

Further power for Stage I and Stage II is also optionally split from a single optical pump source, and can be further divided in Stage I to provide independent pump power at the same or the different wavelengths

In other embodiments, stage II optical gain medium may comprise a monolithic optical amplifier, that can be integrated onto the same planar waveguide device as stage I, or a separate EDFA.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims

1. A laser for producing light having a plurality of wavelengths, comprising:
a) a first stage ring oscillator comprising;
i) a plurality of independent gain mediums disposed in a parallel circuit between a de-multiplexing filter and a combiner,
ii) a comb filter
iii) an unidirectional coupler disposed between said comb filter and the de-multiplexing filter for receiving optical power from the multiplexing filter, and providing a first portion of the power to the comb filter,
b) a second stage for receiving a second portion of the power from said unidirectional coupler, said second having an optical gain medium for amplifying the optical power to provide a laser output beam having multiple beams of discreet wavelengths selected by said comb filter.

2. A laser for producing light having a plurality of wavelengths according to claim 1 wherein said combiner is a multiplexing filter.

3. A laser for producing light having a plurality of wavelengths according to claim 1 wherein said unidirectional coupler further comprises an optical isolator.

4. A laser for producing light having a plurality of wavelengths according to claim 1 further comprising a variable attenuator disposed in series with each of the optical gain mediums in Stage I between the de-multiplexing filter and the combiner.

5. A laser for producing light having a plurality of wavelengths according to claim 1 wherein said comb filter is selected from the group consisting of a F-P Etalon filter, a thin film interference bandpass filter, a thin film interference minus filter type, an etalon filter, and a Fabry-Perot semiconductor optical amplifier filter.

6. A laser for producing light having a plurality of wavelengths according to claim 1 wherein said de-multiplexing filter is selected from the group consisting of a F-P Etalon filter, a thin film interference bandpass filter, a thin film interference minus filter type, an etalon filter, a Fabry-Perot semiconductor optical amplifier filter, a planar arrayed waveguide, a fiber bragg grating and a diffraction grating.

7. A laser for producing light having a plurality of wavelengths according to claim 1 wherein the independent gain mediums of the first stage again medium are selected from the group consisting of doped optical fiber, semiconductor optical amplifier, parametric amplifier and Raman and Brillouin amplifier.

8. A method of providing a plurality of wavelengths, the method comprising:
i) providing a laser having;
(1) a first stage ring oscillator comprising;
(a) a plurality of independent gain mediums disposed in a parallel circuit between a de-multiplexing filter and a combiner,
(b) a comb filter
(c) an unidirectional coupler disposed between said comb filter and the de-multiplexing filter for receiving optical power from the multiplexing filter, and providing a first portion of the power to the comb filter,
(2) a second stage comprising an optical gain medium receiving a second portion of the power from said unidirectional coupler.
ii) exciting lasing conditions in 2 or more of the independent gain medium of stage I,
iii) regulating the pump power applied to the optical gain medium in the second stage to amplify a plurality of multiple wavelengths excited in the first stage.

9. A method of providing a plurality of wavelengths according to claim 8, the method further comprising;
a) modifying the output beam wavelengths,

10. A method of providing a plurality of wavelengths according to claim 9 wherein the method of modifying the output beam wavelengths comprises;
a) modulating the transmission wavelength of the de-multiplexing filter of the first stage.

11. A method of providing a plurality of wavelengths according to claim 9 wherein the method of modifying the output beam wavelengths comprises;
a) modulating the transmission wavelength of the comb filter of the first stage.

12. A method of providing a plurality of wavelengths according to claim 9 wherein the method of modifying the output beam wavelengths comprises;
a) modulating the output from one or more of the independent gain medium before de-multiplexing filter and combiner.

13. A method of providing a plurality of wavelengths according to claim 12 wherein the method of modulating the output from one or more of the independent gain medium comprises;
a) attenuating the output from one or more the independent gain medium before de-multiplexing filter and combiner.

14. A method of providing a plurality of wavelengths according to claim 12 wherein the method of modulating the output from one or more of the independent gain medium comprises;
a) modulating the pump power applied to the independent gain medium before de-multiplexing filter and combiner.

15. A laser for producing light having a plurality of wavelengths, comprising:
a) a first stage ring oscillator comprising;
i) a plurality of independent gain mediums disposed in a parallel circuit between a de-multiplexing filter and a combiner,
ii) a comb filter
iii) an unidirectional coupler disposed between said comb filter and the de-multiplexing filter for receiving optical power from the multiplexing filter, and providing a first portion of the power to the comb filter,
b) a second stage for receiving a second portion of the power from said unidirectional coupler, said second having an optical gain medium for amplifying the power optical power to provide a laser output beam having multiple beams of discreet wavelengths selected by said comb filter,
c) wherein a least one of said first stage and said second stage is formed as a planar integrated optical component.

16. A laser for producing light having a plurality of wavelengths according to claim 15 wherein at least one of said comb filter and de-multiplexing is a planar arrayed-waveguide grating.

17. A laser for producing light having a plurality of wavelengths according to claim 15 wherein the independent gain mediums of the first stage are semiconductor optical amplifiers fabricated on a common semiconductor substrate.
